(19) United States
(12) Patent Application Publication
(10) Pub. No.: US 2024/0269022 A1
(43) Pub. Date: Aug. 15, 2024

(54) Retention Assembly For Lift Assembly Of Patient Support Apparatus

(71) Applicant: Stryker Corporation, Kalamazoo, MI (US)

(72) Inventors: Connor F. St. John, Kalamazoo, MI (US); William D. Childs, Plainwell, MI (US); Tyler Ethen, Portage, MI (US)

(73) Assignee: Stryker Corporation, Kalamazoo, MI (US)

(21) Appl. No.: 18/564,664

(22) PCT Filed: May 27, 2022
(86) PCT No.: PCT/US2022/031240

§ 371 Date: Nov. 28, 2023

Related U.S. Application Data
(60) Provisional application No. 63/194,232, filed on May 28, 2021.

(51) Int. Cl. A61G 7/012; F16C 11/04

(52) U.S. Cl. CPC A61G 7/012; F16C 11/045; F16C 2316/10

(57) ABSTRACT

A patient support apparatus comprises a base and a support frame. The patient support apparatus also comprises a lift assembly that operates to lift and lower the support frame relative to the base. The lift assembly comprises lift members that extend and collapse to lift and lower the support frame. A timing link is pivotally connected to one of the lift members and pivotally connected to the base. Guides operate to guide movement of the lift members during operation. Retention assemblies are arranged between pivoting components of the lift assembly.

### CROSS-REFERENCE TO RELATED APPLICATIONS

The subject patent application claims priority to, and all the benefits of, U.S. Provisional Patent Application No. 63/194,232, filed on May 28, 2021, the entire contents of which are incorporated by reference herein.

### BACKGROUND

Patient support apparatuses, such as hospital beds, stretchers, cots, tables, and wheelchairs, facilitate care of patients in a health care setting. Conventional patient support apparatuses comprise a base, a support frame upon which the patient is supported, and a lift assembly for lifting and lowering the support frame relative to the base. Sometimes, it is desirable for the lift assembly to be capable of moving the support frame to a minimum height that eases ingress and egress of the patient and a maximum height that eases access to patients by caregivers. However, limitations on where a typical lift assembly can be placed on a patient support apparatus, due to the large amount of space required, often make providing a suitable range between the minimum height and the maximum height difficult. For instance, a typical lift assembly utilizes space-consuming linear actuators and lift legs to lift and lower the support frame relative to the base.

Depending on the specific configuration of the lift assembly, various components of the lift assembly may articulate relative to each other and may pivot about various axes as the height of the support frame is adjusted relative to the base. In order to facilitate ease of assembly, manufacture, and service, certain components are typically pinned, bolted, or otherwise supported for relative rotation about different types of shafts, bearings, bushings, and the like. Here, it will be appreciated that removable fasteners may advantageously improve the assembly and/or manufacture of the patient support apparatus but may be susceptible to tampering or even inadvertent loosening. For example, unthreading of bolts and nuts can result in inadvertent loosening. By way of further example, the use of clevis pins with cotter pins can typically be disassembled by hand and may occupy an undesirably large area adjacent to the axis. Furthermore, the arrangement of the axes relative to other components of the lift assembly may make axial installation of certain types of fasteners problematic, such as with threaded bolts and nuts or other axially-installed fasteners. Here, by way of further example, claw spring washers are installed axially, and afford a certain amount of anti-tamper protection in that they typically have to be destroyed in order to be removed, but both the process of installing and removing these types of fasteners increases the risk of damage to adjacent components, as well as to the surface finish of the shaft to which it is installed.

A patient support apparatus with a lift assembly designed to overcome one or more of the aforementioned disadvantages is desired.

### SUMMARY

In one aspect, an implementation of a patient support apparatus may comprise a base, a support frame supported by the base, and a patient support deck disposed on the support frame and defining a patient support surface. The patient support apparatus may further comprise a lift assembly operatively arranged between the base and the support frame and configured to effect movement of the support frame relative to the base. The lift assembly may include a first link and a second link each defining a respective link aperture and a retention assembly. The retention assembly may be disposed in each of the link apertures to pivotably couple the first link to the second link. The retention assembly may comprise a pin disposed in each of the link apertures. The pin may define a cross bore. The retention assembly may further comprise a retention cap defining a cap aperture extending therethrough. The retention cap may be disposed on the pin with the cap aperture aligned with the cross bore. The retention assembly may further comprise a cross-pin disposed in the cross bore and protruding from the cap aperture configured to retain the retention cap to the pin and limit axial movement of the first and second links.

In another implementation a patient support apparatus may comprise a base, a support frame supported by the base, and a patient support deck disposed on the support frame and defining a patient support surface. The patient support assembly may further comprise a lift assembly operatively arranged between the base and the support frame and configured to effect movement of the support frame relative to the base. The lift assembly may include a first lift member and a pin operatively attached to the first lift member and extending along an axis to a pin end with a cross bore defined extending transverse to the axis proximate the pin end. The lift assembly may further comprise a second lift member defining a link aperture pivotably supported about the pin and a retention cap disposed at the pin end of the pin. The retention cap may define a cap aperture aligned with the cross bore of the pin. The lift assembly may further comprise a cross-pin disposed in the cross bore and protruding from the cap aperture configured to retain the retention cap to the pin and limit axial movement of the first and second links.

In another aspect, one implementation of a retention assembly for a pivoting connection of a lift assembly for a patient support apparatus may comprise a pin extending along a pivot axis from a pin flange to a pin end and defining a cross bore proximate to the pin end. The retention assembly may further comprise a retention cap comprising a retention body extending between a retention flange and a retention end with a cap aperture defined in the retention body. The retention cap may be disposed on the pin end with the cap aperture aligned with the cross bore. The retention assembly may further comprise a cross-pin disposed in the cross bore and protruding from the cap aperture configured to retain the retention cap to the pin and limit axial movement of the pivoting connection.

In another aspect, an implementation of a patient support apparatus includes a base and a lift assembly having a first link and a second link each defining a link aperture and supported by the base. The lift assembly further includes a retention assembly including a pin defining a cross bore, a retention cap defining a cap aperture, and a rivet. A method of assembling the patient support apparatus may comprise inserting the pin into the link aperture of the first link and the second link and arranging the retention cap on an end of the pin. The method may further comprise aligning the cap aperture with the cross bore, inserting the rivet through the cap aperture and the cross bore in an initial configuration; and deforming the rivet from the initial configuration to a secured configuration.

Any of the above aspects can be combined in full or in part. Any features of the above aspects can be combined in full or in part. Any of the above implementations for any aspect can be combined with any other aspect. Any of the above implementations can be combined with any other implementation whether for the same aspect or a different aspect.

### BRIEF DESCRIPTION OF THE DRAWINGS

Advantages of the present disclosure will be readily appreciated as the same becomes better understood by reference to the following detailed description when considered in connection with the accompanying drawings.

FIG. 1 is a perspective view of a patient support apparatus.

FIG. 2 is a perspective view of a lift assembly of the patient support apparatus at a maximum height.

FIG. 3 is a perspective view of the lift assembly of the patient support apparatus at a minimum height.

FIG. 4 is a perspective view of a portion of the lift assembly.

FIG. 5 is a cross-sectional and elevational view of the lift assembly at the maximum height.

FIG. 6 is a cross-sectional and elevational view of the lift assembly at the minimum height.

FIG. 7 is a perspective view of an alternative lift assembly of the patient support apparatus.

FIG. 8 is another perspective view of the alternative lift assembly of the patient support apparatus.

FIG. 9 is an elevational view of the alternative lift assembly.

FIG. 10 is a close-up elevational view of a portion of the alternative lift assembly.

FIG. 11 is a partial perspective view of an alternative lift assembly.

FIG. 12 is a partial perspective view of an alternative lift assembly.

FIG. 13 is a partial perspective view of an alternative lift assembly.

FIG. 14 is a perspective view depicting portions of a lift member of an alternative lift assembly, shown having retention assemblies according to versions of the present disclosure.

FIG. 15 is an enlarged, partial perspective view of one of the retention assemblies of FIG. 14, shown having a retention cap.

FIG. 16 is a partial section view taken along indicia 16 of FIG. 15.

FIG. 17 is a partial, exploded perspective view depicting portions of the retention assembly and the lift member of FIGS. 14-16.

FIG. 18 is an enlarged perspective view of a retention cap of the retention assembly of FIGS. 15-17 showing a retention end.

FIG. 19 is another enlarged perspective view of the retention cap of FIG. 18 showing a flange end.

### DETAILED DESCRIPTION

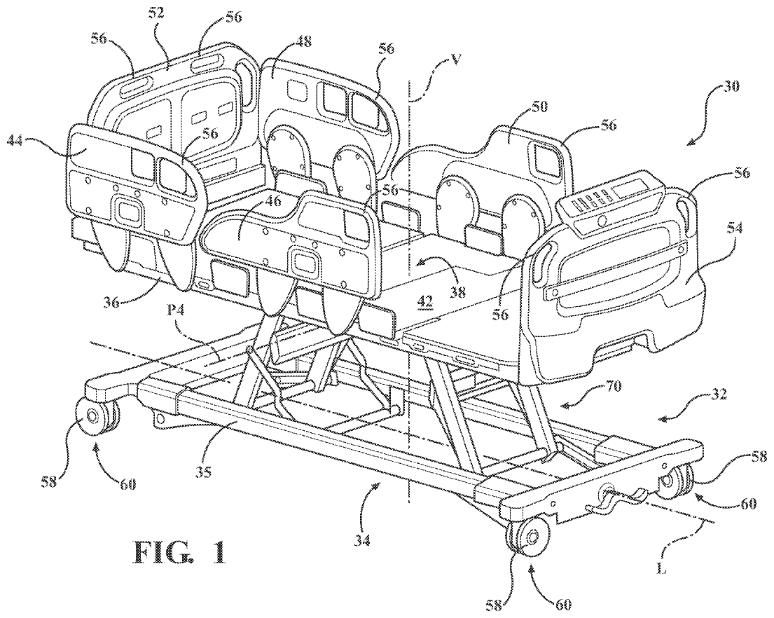

Referring to FIG. 1, a patient support apparatus 30 is shown for supporting a patient in a health care setting. The patient support apparatus 30 illustrated in FIG. 1 comprises a hospital bed. In other versions, however, the patient support apparatus 30 may comprise a stretcher, cot, table, wheelchair, or similar apparatus utilized in the care of a patient.

A support structure 32 provides support for the patient. The support structure 32 illustrated in FIG. 1 comprises a base 34 and a support frame 36. The base 34 comprises a base frame 35. The support frame 36 is spaced above the base frame 35 in FIG. 1. The support structure 32 also comprises a patient support deck 38 disposed on the support frame 36. The patient support deck 38 comprises several sections, some of which are pivotable relative to the support frame 36, such as a fowler section, a seat section, a thigh section, and a foot section. The patient support deck 38 defines a patient support surface 42 upon which the patient may be supported.

A mattress (not shown) is disposed on the patient support deck 38 during use. The mattress comprises a secondary patient support surface upon which the patient is supported. The base 34, support frame 36, patient support deck 38, and patient support surfaces 42 each have a head end and a foot end corresponding to designated placement of the patient's head and feet on the patient support apparatus 30. The base 34 comprises a longitudinal axis L along its length from the head end to the foot end. The base 34 also comprises a vertical axis V arranged crosswise (e.g., perpendicular) to the longitudinal axis L along which the support frame 36 is lifted and lowered relative to the base 34. The construction of the support structure 32 may take on any known or conventional design and is not limited to that specifically set forth above. In addition, the mattress may be omitted in certain versions, such that the patient rests directly on the patient support surface 42.

Side rails 44, 46, 48, 50 are coupled to the support frame 36 and thereby supported by the base 34. A first side rail 44 is positioned at a right head end of the support frame 36. A second side rail 46 is positioned at a right foot end of the support frame 36. A third side rail 48 is positioned at a left head end of the support frame 36. A fourth side rail 50 is positioned at a left foot end of the support frame 36. If the patient support apparatus 30 is a stretcher or a cot, there may be fewer side rails. The side rails 44, 46, 48, 50 are movable between a raised position in which they block ingress and egress into and out of the patient support apparatus 30, one or more intermediate positions, and a lowered position in which they are not an obstacle to such ingress and egress. In still other configurations, the patient support apparatus 30 may not include any side rails.

A headboard 52 and a footboard 54 are coupled to the support frame 36. In other versions, when the headboard 52 and footboard 54 are included, the headboard 52 and footboard 54 may be coupled to other locations on the patient support apparatus 30, such as the base 34. In still other versions, the patient support apparatus 30 does not include the headboard 52 and/or the footboard 54.

Caregiver interfaces 56, such as handles, are shown integrated into the footboard 54 and side rails 44, 46, 48, 50 to facilitate movement of the patient support apparatus 30 over floor surfaces. Additional caregiver interfaces 56 may be integrated into the headboard 52 and/or other components of the patient support apparatus 30. The caregiver interfaces 56 are graspable by the caregiver to manipulate the patient support apparatus 30 for movement.

Other forms of the caregiver interface 56 are also contemplated. The caregiver interface may comprise one or more handles coupled to the support frame 36. The caregiver interface may simply be a surface on the patient support apparatus 30 upon which the caregiver logically applies force to cause movement of the patient support apparatus 30 in one or more directions, also referred to as a push location. This may comprise one or more surfaces on the support frame 36 or base 34. This could also comprise one or more surfaces on or adjacent to the headboard 52, footboard 54, and/or side rails 44, 46, 48, 50. In other versions, the caregiver interface may comprise separate handles for each hand of the caregiver. For example, the caregiver interface may comprise two handles.

Wheels 58 are coupled to the base 34 to facilitate transport over the floor surfaces. The wheels 58 are arranged in each of four quadrants of the base 34 adjacent to corners of the base 34. In the version shown, the wheels 58 are caster wheels able to rotate and swivel relative to the support structure 32 during transport. Each of the wheels 58 forms part of a caster assembly 60. Each caster assembly 60 is mounted to the base 34. It should be understood that various configurations of the caster assemblies 60 are contemplated. In addition, in some versions, the wheels 58 are not caster wheels and may be non-steerable, steerable, non-powered, powered, or combinations thereof. Additional wheels are also contemplated. For example, the patient support apparatus 30 may comprise four non-powered, non-steerable wheels, along with one or more powered wheels. In some cases, the patient support apparatus 30 may not include any wheels.

In other versions, one or more auxiliary wheels (powered or non-powered), which are movable between stowed positions and deployed positions, may be coupled to the support structure 32. In some cases, when these auxiliary wheels are located between caster assemblies 60 and contact the floor surface in the deployed position, they cause two of the caster assemblies 60 to be lifted off the floor surface thereby shortening a wheelbase of the patient support apparatus 30. A fifth wheel may also be arranged substantially in a center of the base 34.

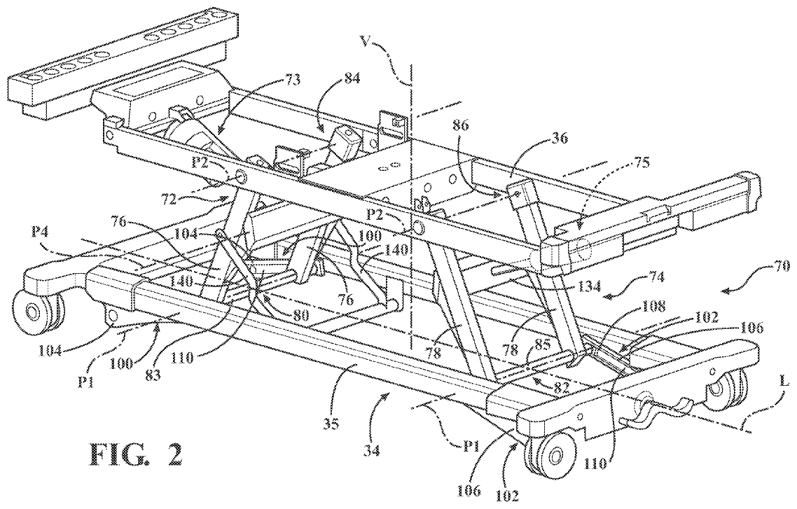

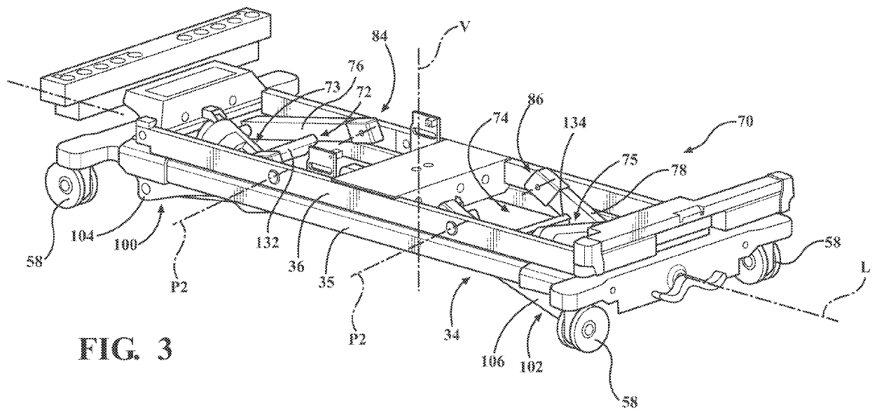

Referring to FIGS. 2 and 3, the patient support apparatus 30 comprises a lift assembly 70 that operates to lift and lower the support frame 36 relative to the base 34. The lift assembly 70 is configured to move the support frame 36 from a minimum height (shown in FIG. 3) to a maximum height (shown in FIG. 2), or to any desired position in between.

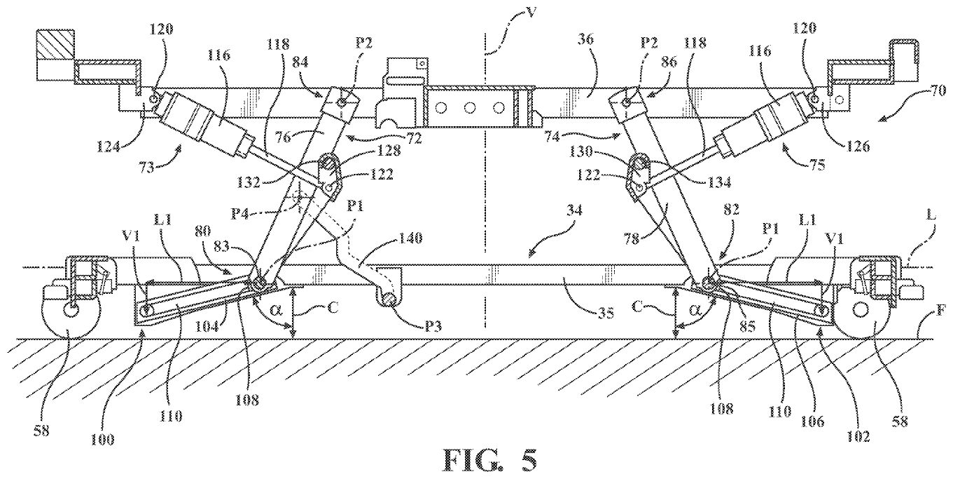

The lift assembly 70 comprises head end and foot end lift members 72, 74. First and second actuators 73, 75 (see also FIG. 5) move the lift members 72, 74 to lift and lower the support frame 36 relative to the base 34. The first actuator 73 is coupled to the head end lift member 72. The second actuator 75 is coupled to the foot end lift member 74. The actuators 73, 75 operate to pivot their respective lift member 72, 74 about fixed upper pivot axes P2 to lift and lower the support frame 36 relative to the base 34, as described further below. The actuators 73, 75 comprise linear actuators, rotary actuators, or other types of actuators. The actuators 73, 75 may be electrically operated and/or may be hydraulic. In the version shown, the actuators 73, 75 are electro-hydraulic, linear actuators, such as compact electro-hydraulic actuators available from Parker Hannifin Corp., Marysville, Ohio, e.g., Part No. 649346. In other versions, the actuators 73, 75 can be electric, linear actuators. It is contemplated that, in some versions, only one lift member and one associated actuator may be employed, e.g., to raise only one end of the support frame 36.

The lift members 72, 74 comprise a pair of head end lift legs 76 and a pair of foot end lift legs 78 pivoted by the actuators 73, 75 about the fixed upper pivot axes P2. In other versions, each of the lift members 72, 74 may comprise a single lift leg. In still other versions, other types of lifting members capable of lifting and lowering the support frame 36 may be employed. The lift members 72, 74 may be identical in form or may have different forms. For instance, one of the lift members 72, 74 may be a single lift leg, while the other of the lift members 72, 74 may comprise part of a scissor-type mechanism. It should be appreciated that each of the lift members 72, 74 may be formed in a unitary construction or may be separate pieces fastened together.

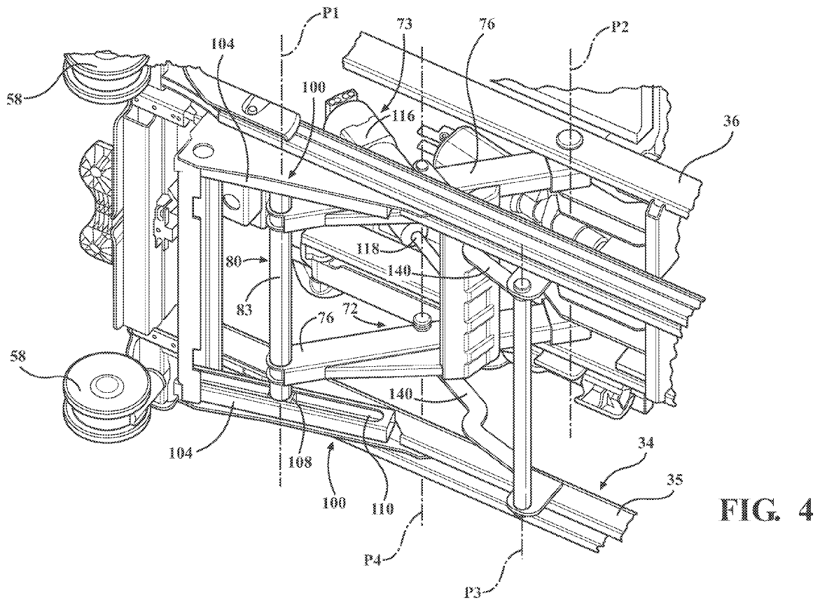

The lift members 72, 74 comprise first end sections 80, 82 movably coupled to the base 34. In particular, the first end sections 80, 82 are connected to guided bodies 108 (see FIG. 4) that slide in head end and foot end guides 100, 102 relative to the base 34 during the lifting and lowering of the support frame 36, i.e., when the actuators 73, 75 pivot the lift members 72, 74 about the fixed upper pivot axes P2. In the version shown, the first end sections 80, 82 comprise first ends of the lift legs 76, 78 and a support member 83, 85 interconnecting each pair of the lift legs 76, 78, respectively, at their first ends. In the version shown, the support members 83, 85 are rigidly fixed to the lift legs 76, 78 to move with the lift legs 76, 78. The support members 83, 85 define a moving lower pivot axis P1 about which the support members 83, 85 pivot as the first end sections 80, 82 slide relative to the base 34. In other versions, the lift legs 76, 78 may pivot relative to the support members 83, 85.

The lift members 72, 74 extend from the first end sections 80, 82 to second end sections 84, 86. The second end sections 84, 86 are pivotally connected to the support frame 36 at the fixed upper pivot axes P2 for pivoting relative to the support frame 36. In the version shown, the second end sections 84, 86 comprise second ends of the lift legs 76, 78. The fixed upper pivot axes P2 lie in a common plane perpendicular to the vertical direction when the support frame 36 is at the minimum height or the maximum height.

The guides 100, 102 are arranged to guide the movement of the first end sections 80, 82 when the actuators 73, 75 pivot the lift members 72, 74 about the fixed upper pivot axes P2 to lift and lower the support frame 36 relative to the base 34. The head end guides 100 guide movement of the head end lift member 72. The foot end guides 102 guide movement of the foot end lift member 74. In the version shown, four guides 100, 102 are provided. The four guides 100, 102 comprise a pair of head end guide tracks 104 and a pair of foot end guide tracks 106. The guide tracks 104, 106 are fixed to the base 34 and have a hollow, elongated shape. In particular, the guide tracks 104, 106 are shown being formed of rectangular tubing. In other versions, the guides 100, 102 may assume other forms or shapes capable of guiding movement of the first end sections 80, 82 of the lift members 72, 74.

Referring to FIG. 4, the guided bodies 108 are rotatably coupled to the lift members 72, 74 to rotate relative to the lift members 72, 74 when sliding in the guides 100, 102. More specifically, the guided bodies 108 are rotatably connected at each end of the support members 83, 85 to pivot about the lower pivot axes P1 as the guided bodies 108 slide in the guide tracks 104, 106. The guided bodies 108 are captured in the guide tracks 104, 106 to prevent withdrawal. In the version shown, the guided bodies 108 comprise blocks and the guide tracks 104, 106 comprise slide-bearing guide tracks in which the blocks slide. The blocks can be any shape, including box-shaped, spherical, cylindrical, or the like. In other versions, the guided bodies 108 comprise rollers, gears, or other movable elements. In further versions, the guide tracks 104, 106 comprise racks and the guided bodies 108 comprise gears movable along the racks.

The guide tracks 104, 106 comprise guide slots 110 through which the support members 83, 85 are rotatably connected to the guided bodies 108. The guide slots 110 are shaped to be at least one of linear or arcuate. In the version shown, the guide slots 110 are linear. In some versions, the guide slots 110 have a linear portion and an arcuate portion. In still other versions, the guide slots 110 are formed with other shapes. The shape of the guide tracks 104, 106 and the guide slots 110 dictate the path along which the support members 83, 85, and by extension, the first end sections 80, 82, follow during movement of the lift members 72, 74.

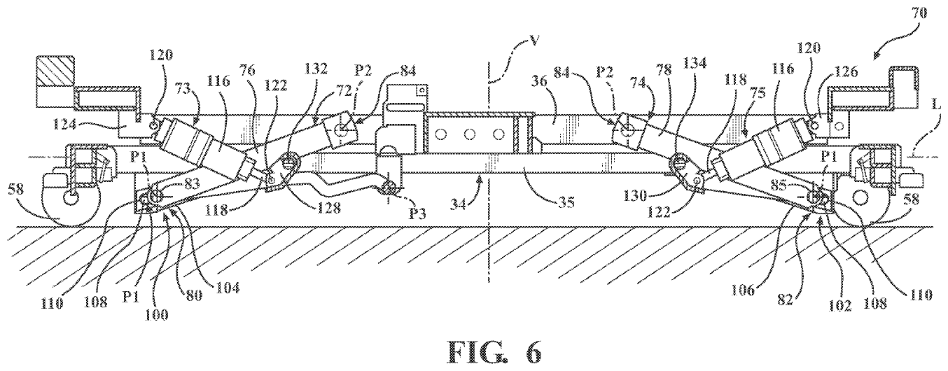

Referring to FIG. 5, the guide tracks 104, 106 are obliquely oriented (e.g., askew) with respect to the base 34 and the vertical axis V when the support frame 36 is at the minimum height or the maximum height. More specifically, the guide tracks 104, 106 may be oriented at an acute angle α to the vertical axis V of more than 0 degrees and less than 90 degrees, from 1 degree to 89 degrees, from 5 degrees to 85 degrees, from 10 degrees to 80 degrees, from 20 degrees to 70 degrees, from 30 degrees to 60 degrees, from 40 degrees to 50 degrees, or between 0 degrees and 90 degrees. The guide tracks 104, 106 are fixed to the base frame 35 so that one end of the guide tracks 104, 106 extends below the base frame 35. As a result, the support members 83, 85, and by extension, the first end sections 80, 82, extend below the base frame 35 when the support frame 36 is at the minimum height (see FIG. 6). As a result of this orientation, clearance C is provided between the guides 100, 102 and a floor surface F. The clearance is at least five inches between at least a portion of the guide tracks 104, 106 and the floor surface F. In other versions, the clearance may be greater than five, six, seven, eight, nine, or ten inches. In still other versions, the clearance is no greater than five, six, seven, eight, nine, or ten inches.

Owing to the fixed upper pivot axes P2, the support frame 36 is fixed from moving longitudinally or vertically relative to the second end sections 84, 86 as the support frame 36 is lifted or lowered relative to the base 34. Conversely, owing to the oblique orientation of the guide tracks 104, 106, the first end sections 80, 82 are longitudinally and vertically displaced relative to the base 34 when the actuators 73, 75 pivot the lift members 72, 74 about the fixed upper pivot axes P2. More specifically, for instance when lowering the support frame 36, the first end sections 80, 82 are longitudinally displaced by a longitudinal distance L1 and vertically displaced by a vertical distance V1. By virtue of their arrangement, the guide tracks 104, 106 and the guided bodies 108 cooperate in a manner that contribute to the lifting and lowering of the support frame 36 relative to the base 34. In other words, owing to the oblique orientation of the guide tracks 104, 106 relative to the vertical axis V, when the first end sections 80, 82 move in the guide tracks 104, 106, the lift members 72, 74 lift or lower relative to the base 34. This additional lifting or lowering of the lift members 72, 74 enhances the range between the maximum height and the minimum height.

The guide tracks 104, 106 and the lift members 72, 74 are arranged so that the first end sections 80, 82 move toward one another as the support frame 36 is lifted relative to the base 34 and the first end sections 80, 82 move away from one another as the support frame 36 is lowered relative to the base 34.

In the version shown, each of the actuators 73, 75 comprises a housing 116 and a drive rod 118 that extends and retracts relative to the housing 116 to pivot the lift members 72, 74 about their fixed upper pivot axes P2. The actuators 73, 75 have a housing end 120 that is pivotally connected to the support frame 36. The actuators 73, 75 extend from the housing end 120 to a rod end 122 that is pivotally connected to the lift members 72, 74. The actuators 73, 75 are pivotally connected to the support frame 36 and the lift members 72, 74 at actuator mounts.

In the version shown, the actuator mounts comprise pivot brackets 124, 126, 128, 130. Two of the pivot brackets 124, 126, 128, 130 are fixed to the support frame 36 to support the housing ends 120. In particular, one pivot bracket 124 is fixed to the support frame 36 to which the housing end 120 of the first actuator 73 is pivotally connected by a pivot element, such as a pivot pin. Another pivot bracket 126 is fixed to the support frame 36 to which the housing end 120 of the second actuator 75 is pivotally connected by a pivot element, such as a pivot pin.

The other two of the pivot brackets 124, 126, 128, 130 are fixed to the lift members 72, 74 to support the rod ends 122. In particular, one pivot bracket 128 is coupled to the head end lift member 72. Another pivot bracket 130 is coupled to the foot end lift member 74. These pivot brackets 128, 130 are fixed to cross links 132, 134 that interconnect each pair of the head end and foot end lift legs 76, 78 about midway along a length of the lift legs 76, 78. The rod end 122 of the first actuator 73 is pivotally connected to the pivot bracket 128. The rod end 122 of the second actuator 75 is pivotally connected to the other pivot bracket 130. The rod ends 122 are pivotally connected to the lift members 72, 74 so that as the actuators 73, 75 are operated, the rod ends 122 extend and retract relative the housings 116 to move (e.g., pivot) the lift members 72, 74 and lift and lower the support frame 36 relative to the base 34.

Timing links 140 are pivotally connected at a first end to one of the lift legs 76, 78 and pivotally connected at a second end to the base frame 35. In particular, in the version shown, two timing links 140 are pivotally connected to the base frame 35 to pivot about a third pivot axis P3 and are pivotally connected to the head end lift legs 76 to pivot about a fourth pivot axis P4. In the version shown, the ends of the timing links 140 pivotally connected to the base frame 35 are pivotally connected to brackets fixed to the base frame 35 that extend below the base frame 35. This arrangement enables the lift members 72, 74 to further collapse when moving to the minimum height. Torsion springs could be added at pivot axes P2, P4 for smoother lifting and lowering of the support frame 36.

Additional timing links 140 could also be pivotally connected to the foot end lift legs 78 in other versions. The timing links 140 constrain movement of the head end lift legs 76 during lifting and lowering so that, when the actuators 73, 75 are operated simultaneously to lift and lower the support frame 36, the head end and the foot end of the support frame 36 are lifted and lowered evenly relative to the base 34 without any relative longitudinal motion between the support frame 36 and the base 34. The actuators 73, 75 can also be operated independently to place the support frame 36 in a Trendelenburg or reverse Trendelenburg position.

A control system (not shown) is provided to control operation of the actuators 73, 75. The control system comprises a controller having one or more microprocessors for processing instructions or for processing an algorithm stored in memory to control operation of the actuators 73, 75 to coordinate movement of the actuators 73, 75 to evenly lift and lower the support frame 36 relative to the base 34 or to independently operate the actuators 73, 75 to place the support frame 36 in the Trendelenburg or reverse Trendelenburg positions.

Additionally or alternatively, the controller may comprise one or more microcontrollers, field programmable gate arrays, systems on a chip, discrete circuitry, and/or other suitable hardware, software, or firmware that is capable of carrying out the functions described herein. The controller may be carried on-board the patient support apparatus 30 or may be remotely located. In one version, the controller is mounted to the base 34. In other versions, the controller is mounted to the footboard 54. Power to the actuators 73, 75 and/or the controller may be provided by a battery power supply or an external power source.

The controller is coupled to the actuators 73, 75 in a manner that allows the controller to control the actuators 73, 75. The controller may communicate with the actuators 73, 75 via wired or wireless connections to perform one of more desired functions.

The controller may monitor a current state of the actuators 73, 75 and determine desired states in which the actuators 73, 75 should be placed, based on one or more input signals that the controller receives from one or more input devices. The state of the actuators 73, 75 may be a position, a relative position, an angle, an energization status (e.g., on/off), or any other parameter of the actuators 73, 75.

The user, such as a caregiver, may actuate a user input device (not shown), which transmits a corresponding input signal to the controller, and the controller controls operation of the actuators 73, 75 based on the input signal. The user input devices may comprise any device capable of being actuated by the user. The user input devices may be configured to be actuated in a variety of different ways, including but not limited to, mechanical actuation (hand, foot, finger, etc.), hands-free actuation (voice, foot, etc.), and the like. The user input devices may comprise buttons (such as buttons corresponding to lift, lower, Trendelenburg, and reverse Trendelenburg), a gesture sensing device for monitoring motion of hands, feet, or other body parts of the user (such as through a camera), a microphone for receiving voice activation commands, a foot pedal, and a sensor (e.g., infrared sensor such as a light bar or light beam to sense a user's body part, ultrasonic sensor, etc.). Additionally, the buttons/pedals can be physical buttons/pedals or virtually implemented buttons/pedals such as through optical projection or on a touchscreen. The buttons/pedals may also be mechanically connected or drive-by-wire type buttons/pedals where a user applied force actuates a sensor, such as a switch or potentiometer. It should be appreciated that any combination of user input devices may also be utilized. The user input devices may be located on one of the side rails 44, 46, 48, 50, the headboard 52, the footboard 54, or other suitable locations. The user input devices may also be located on a portable electronic device (e.g., iWatch®, iPhone®, iPad®, or similar electronic devices).

During operation, when a user wishes to move the support frame 36 relative to the base 34, the user actuates one or more of the user input devices. For instance, in the event the user wishes to lower the support frame 36 relative to the base 34, such as moving the support frame 36 from the position shown in FIG. 5 to the position shown in FIG. 6, the user actuates the appropriate user input device. Upon actuation, the controller sends output signals to the actuators 73, 75 to cause operation of the actuators 73, 75 in a manner that causes the support frame 36 to lower. In the version shown, this includes both of the actuators 73, 75 being commanded by the controller to retract their associated drive rods 118 into the housings 116. As a result, owing to the pivotal connection of the rod ends 122 to the lift members 72, 74, each of the lift members 72, 74 pivots about their respective fixed upper pivot axis P2 so that the first end sections 80, 82 of the lift members 72, 74 begin to move away from one another while being guided by the guides 100, 102. In other versions, the pivot axes P2 and guides 100 may be located so that the first end sections 80, 82 move toward one another when lowering the support frame 36 relative to the base 34, such as when the pivot axes P2 are located more toward the head and foot ends of the support frame 36 and the guides 100 are located more toward a center of the base 34.

Due to the oblique orientation of the guide tracks 104, 106 relative to the vertical axis V, as the first end sections 80, 82 move away from one another, the guided bodies 108 are slidably guided in the guide tracks 104, 106 such that the guided bodies 108 move both longitudinally and vertically, up to the entire longitudinal distance L1 and the vertical distance V1. More specifically, the guided bodies 108 that are coupled to the head end lift member 72 move longitudinally toward the head end of the base 34 and the guided bodies 108 that are coupled to the foot end lift member 74 move longitudinally toward the foot end of the base 34, while all of the guided bodies 108 move equally vertically downward. By guiding the guided bodies 108 to move vertically downward, the lift members 72, 74 are lowered, thereby further lowering the support frame 36 to which the lift members 72, 74 are pivotally constrained. This provides an even lower minimum height of the support frame 36 than could otherwise be accomplished if the guide tracks 104, 106 were merely arranged longitudinally along the base, e.g., not oblique.

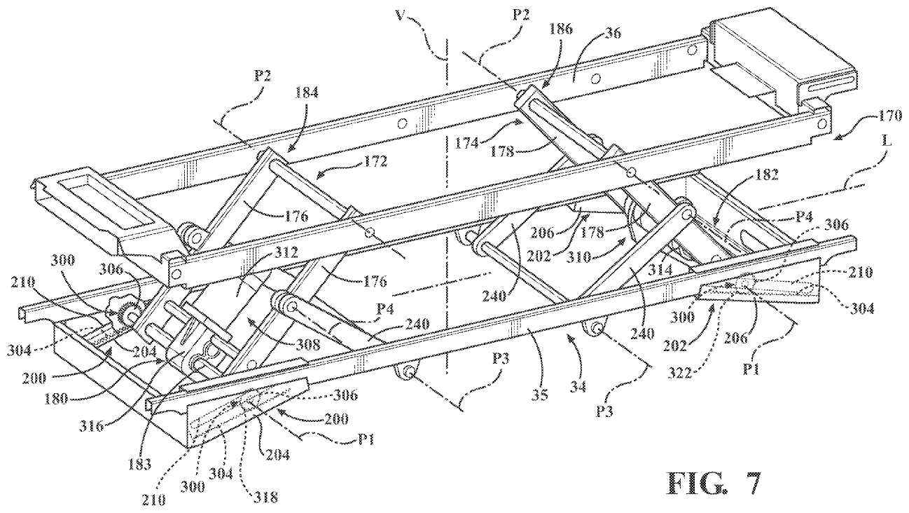

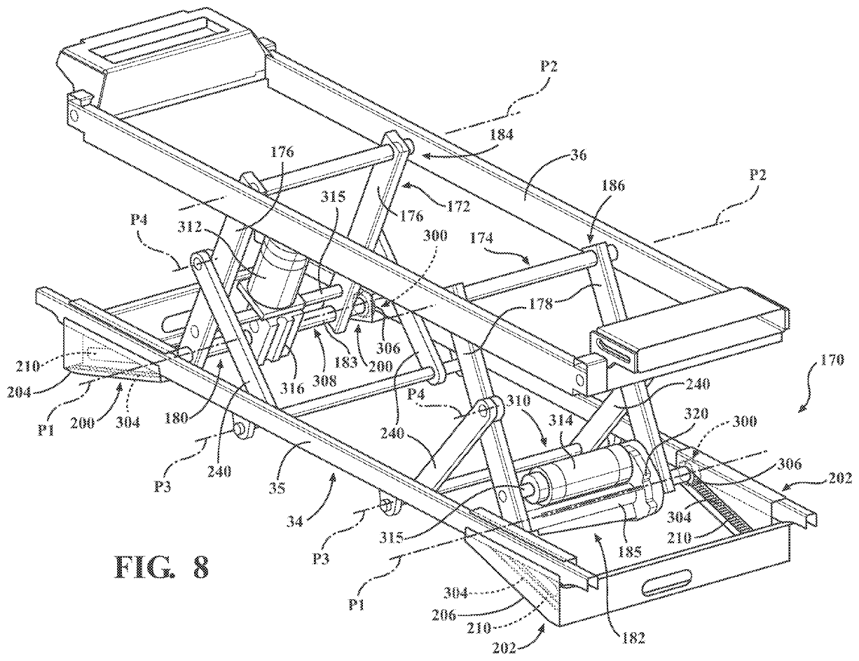

Referring to FIGS. 7 and 8, an alternative lift assembly 170 is shown. The alternative lift assembly 170 is substantially similar to the lift assembly 70. In the lift assembly 170, the numerals are increased by 100 to refer to similar parts as the previously described lift assembly 70. One difference between the lift assemblies 70 and 170 is that the lift assembly 170 comprises driven members 300 that engage guides 200, 202 in place of the guided bodies 108 that are guided in the guides 100, 102 of the previous versions. Unlike the previously described versions in which the guided bodies 108 are passive and slide within the guides 100, 102 as a result of actuation of the actuators 73, 75, the driven members 300 are active and are driven by rotary actuators 308, 310 to move in the guides 200, 202. In other words, the driven members 300, 302 are configured to engage and cooperate with the guides 200, 202 to lift and lower the support frame 36 relative to the base 34. Also in this version, crossbars (not numbered) extend between the lift legs 176, 178 at pivots axes P2, but may be absent as in the prior described versions.

The guides 200, 202 comprise a pair of head end guide tracks 204 and a pair of foot end guide tracks 206. The head end guide tracks 204, as in the prior described versions, guide movement of a head end lift member 172 comprising a pair of head end lift legs 176 as the head end lift member 172 pivots about a fixed upper pivot axis P2. The foot end guide tracks 206 similarly guide movement of a foot end lift member 174 comprising a pair of foot end lift legs 178 as the foot end lift member 174 pivots about a fixed upper pivot axis P2. The lift members 172, 174 move as a result of the driven members 300, 302 being driven in the guide tracks 204, 206 in order to lift and lower the support frame 36 relative to the base 34.

In the version shown, the guide tracks 204, 206 are fixed to the base 34. In other versions, the guide tracks 204, 206 are fixed to the support frame 36. In the version shown, the guide tracks 204, 206 are fixed to the base 34 in an oblique orientation (e.g., askew) with respect to the vertical axis V when the support frame 36 is at the minimum height or the maximum height. In other versions, the guide tracks 204, 206 are arranged parallel to the longitudinal axis L, i.e., not obliquely relative to the vertical axis V. The guide tracks 204, 206 comprise guide slots 210 similar to the prior versions. It should be appreciated that the guide tracks 204, 206 could be arranged in any suitable orientation.

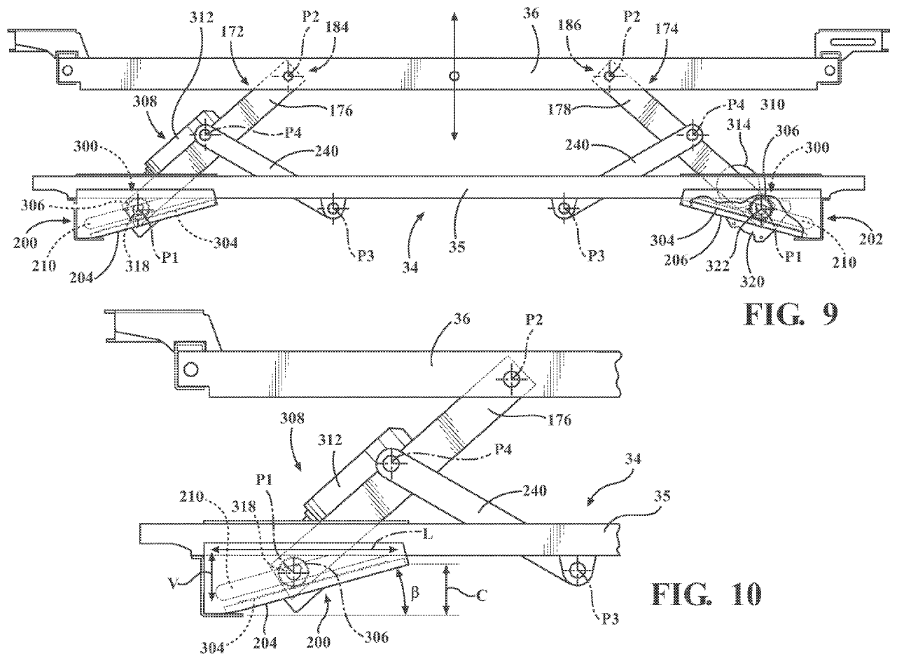

Referring to FIGS. 9 and 10, the driven members 300 are coupled to the lift members 172, 174 to move the lift members 172, 174. The driven members 300 are rotatable relative to the lift members 172, 174 about movable lower pivot axes P1. In the version shown, the guides 200, 202 comprise racks 304 and the driven members 300 comprise drive gears 306 movable along the racks 304, such as in a rack and pinion arrangement, in order to extend or collapse the lift members 172, 174 to lift or lower the support frame 36. The racks 304 are fixed in position relative to the base 34. In other versions, the racks 304 may be movable via a separate actuator (not shown) to further enhance the range between the maximum height and the minimum height. In another version, the guides 200, 202 comprise frictional engagement surfaces and the driven members 300 comprise drive wheels rollable along the frictional engagement surfaces. Other types of driven members are also contemplated.

The rotary actuators 308, 310 are operatively coupled to the driven members 300 to rotate the driven members 300 relative to the lift members 172, 174. In the version shown, a first rotary actuator 308 comprises a first motor 312 operatively coupled to a head end pair of the driven members 300. A second rotary actuator 310 comprises a second motor 314 operatively coupled to a foot end pair of the driven members 300. The head end pair of the driven members 300 are rotatably mounted to the head end lift member 172. The foot end pair of the driven members 300 are rotatably mounted to the foot end lift member 174. In the version shown, the motors 312, 314 rotate the driven members 300 relative to the lift members 172, 174 to travel along the racks 304, which causes the lift members 172, 174 to lift and lower the support frame 36 relative to the base 34. In other versions, the motors 312, 314 may drive the driven members 300 in alternative ways to cooperate with the guides 200, 202 to cause the lift members 172, 174 to lift and lower the support frame 36 relative to the base 34.

Referring to FIGS. 8-10, in the version shown, the first actuator 308 comprises a gearbox 316 (see FIG. 8) to which the first motor 312 is operatively coupled. The gearbox 316 may be a high ratio gearbox, such as one providing a ratio of 60:1 or greater. The gearbox 316 converts rotary motion of the first motor 312 into rotation of a first drive shaft 318 (see FIG. 9) fixed to the head end pair of the driven members 300 to rotate the associated drive gears 306 along the associated racks 304. The first drive shaft 318 is rotatably supported in a support arm 183 (see FIG. 8) that interconnects the pair of the head end lifts legs 176. The first drive shaft 318 is fixed at each end to the associated drive gears 306 through the slots 210 in the head end guide tracks 204. The first drive shaft 318 has a diameter with little clearance in the slots 210 so that the slots 210 constrain movement of the first drive shaft 318 to keep the drive gears 306 in contact with the racks 304, as shown in FIG. 10. The first motor 312 and the gearbox 316 are fixed to the pair of head end lift legs 176 via a cross member 315 (see FIG. 8). As a result, during operation of the first motor 312, the first motor 312 and the gearbox 316 move with the head end lift member 172.

The second actuator 310 comprises a transaxle transmission 320 to which the second motor 314 is operatively connected to form a transaxle motor arrangement. The transaxle transmission 320 is connected to a second drive shaft 322 (see FIG. 9) fixed to the foot end pair of the driven members 300 to rotate the associated drive gears 306 along the associated racks 304. The second drive shaft 322 is rotatably supported in a support arm 185 that interconnects the pair of the foot end lifts legs 178. The second drive shaft 322 is fixed at each end to the associated drive gears 306 through the slots 210 in the foot end guide tracks 206. The second drive shaft 322 has a diameter with little clearance in the slots 210 so that the slots 210 constrain movement of the second drive shaft 322 to keep the drive gears 306 in contact with the racks 304. The second motor 314 and the transaxle transmission 320 are fixed to the pair of foot end lift legs 178 via a cross member 315 (see FIG. 8). As a result, during operation of the second motor 314, the second motor 314 and the transaxle transmission 320 move with the foot end lift member 174.

Timing links 240 are pivotally connected at a first end to the lift legs 176, 178 and pivotally connected at a second end to the base frame 35. In particular, in the version shown, the timing links 240 are pivotally connected to the base frame 35 to pivot about a third pivot axis P3 and are pivotally connected to the lift legs 176, 178 to pivot about a fourth pivot axis P4. Timing links 240 could also be pivotally connected to only one of the lift legs 176, 178 in other versions. The timing links 240 constrain movement of the lift legs 176, 178 during lifting and lowering so that, when the rotary actuators 308, 310 are operated simultaneously to lift and lower the support frame 36, the head end and the foot end of the support frame 36 are lifted and lowered evenly relative to the base 34 without any relative longitudinal motion between the support frame 36 and the base 34. The rotary actuators 308, 310 can also be operated independently to place the support frame 36 in a Trendelenburg or reverse Trendelenburg position.

In other versions, separate actuators may be operatively coupled to each of the driven members 300. Such actuators may each comprise a motor configured to separately rotate separate drive shafts operatively connected to each of the drive gears 306. As a result, the separate actuators are capable of independently driving each of the driven members 300 to lift and lower the support frame 36 relative to the base 34. In yet other versions, instead of different actuators 308, 310 being used to drive the driven members 300, the same actuators 308 or 310 could be used to drive the driven members 300, or any other suitable actuators could be employed.

During operation of the alternative lift assembly 170, when a user wishes to move the support frame 36 relative to the base 34, the user actuates one or more of the user input devices. For instance, in the event the user wishes to lower the support frame 36 relative to the base 34, the user actuates the appropriate user input device. Upon actuation, the controller sends output signals to the actuators 308, 310 to cause operation of the actuators 308, 310 in a manner that causes the support frame 36 to lower. In the version shown, this includes both of the motors 312, 314 being commanded by the controller to operate through the gearbox 316 and the transaxle transmission 320, respectively, to rotate the drive shafts 318, 322 in the support arms 183, 185 thereby rotating the gears 306. The motors 312, 314 are operated so that the gears 306 associated with the head end pair of the driven members 300 ride along their associated racks 304 toward the head end and the gears 306 associated with the foot end pair of the driven members 300 ride along their associated racks 304 toward the foot end. As a result, owing to the pivotal connection of the lift members 172, 174 to the support frame 36 at the fixed upper pivot axes P2, when the head end and foot end pairs of the driven members 300 are driven away from each other in the guide tracks 204, 206, the lift members 172, 174 begin to collapse and the support frame 36 is lowered relative to the base 34.

Due to the oblique orientation of the guide tracks 204, 206 relative to the vertical axis V, as the head end and foot end pairs of the driven members 300 move away from each other, the driven members 300 are guided in the guide tracks 204, 206 such that the driven members 300 move both longitudinally and vertically, up to the entire longitudinal distance L1 and the vertical distance V1. More specifically, the driven members 300 that are coupled to the head end lift member 172 move longitudinally toward the head end of the base 34 and the driven members 300 that are coupled to the foot end lift member 174 move longitudinally toward the foot end of the base 34, while all of the driven members 300 move equally vertically downward. By guiding the driven members 300, 302 to move vertically downward, the lift members 172, 174 are lowered, thereby further lowering the support frame 36 to which lift members 172, 174 are pivotally constrained. This provides an even lower minimum height of the support frame 36 than could otherwise be accomplished if the guide tracks 204, 206 were merely arranged longitudinally along the base, e.g., not oblique. In other versions, however, the guide tracks 204, 206 are arranged longitudinally along the base, such that there is no vertical component of relative motion between the lift members 172, 174 and the base 34, i.e., the driven members 300 are only guided to move longitudinally, not vertically. The driven members 300 could be driven in other possible paths in other versions, such as curvilinear paths, tortuous paths, linear paths, or the like.

Referring to FIG. 11, an alternative lift assembly 570 is shown, which shares features of both of the previously described lift assemblies 70, 170. Like the lift assemblies 70, 170, the alternative lift assembly 570 has a pair of lift members that lift and lower the support frame 36 relative to the base 34. For simplicity, only the lift member 174 is shown. The lift members comprise head end lift legs (not shown) and foot end lift legs 178. Timing links 240, like those in the lift assembly 170, are also present. The lift assembly 570 employs the guides 100, 102 and guided bodies 108 of the lift assembly 70. Only the guides 102 are shown and the guided bodies 108 are obstructed from view.

In this lift assembly 570, the actuators that move the lift legs 178 to lift and lower the support frame 36 relative to the base 34 are the same as the second actuator 310 of the lift assembly 170 and comprises the transaxle transmission 320 to which the second motor 314 is operatively connected to form a transaxle motor arrangement. In this version, the transaxle transmission 320 is connected to a drive shaft 571 fixed to the timing links 240 to rotate the timing links 240 about the pivot axis P3. The second motor 314 and the transaxle transmission 320 are shown fixed to the base frame 35 via a cross member 315 so that as the second actuator 310 operates to rotate the drive shaft 571, the drive shaft 571 rotates relative to the base frame 35 about pivot axis P3. This movement causes the other end of the timing links 240 to pivot about the pivot axis P4 relative to the lift legs 178. This, in turn, pivots the lift legs 178 about the fixed upper pivot axes P2 and causes the guided bodies 108 to move longitudinally and vertically in the guides 100, 102.

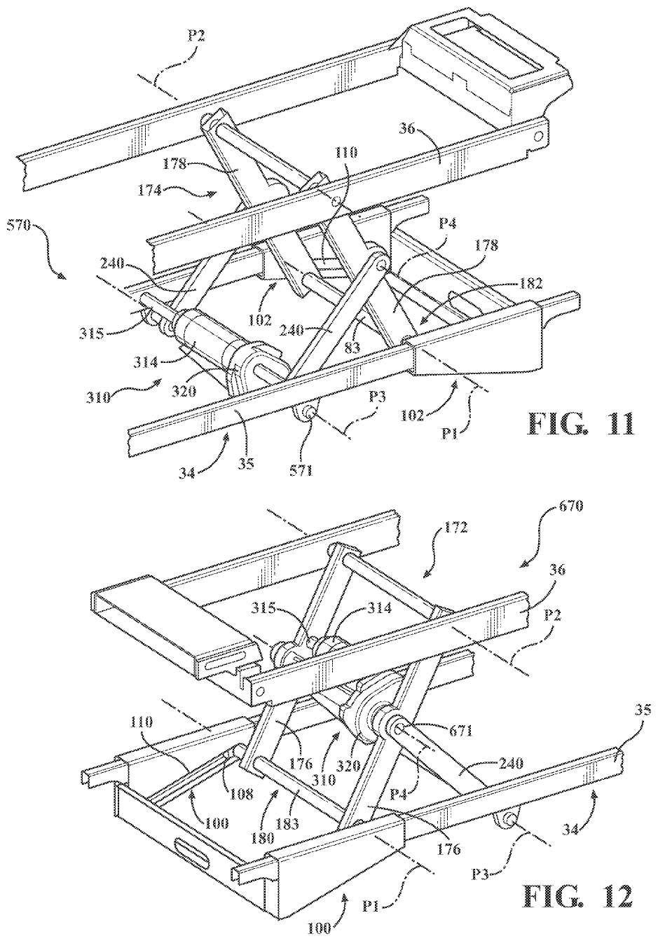

Referring to FIG. 12, an alternative lift assembly 670 is shown, which shares features of both of the previously described lift assemblies 70, 170. Like the lift assemblies 70, 170, the alternative lift assembly 670 has a pair of lift members that lift and lower the support frame 36 relative to the base 34. For simplicity, only the lift member 172 is shown. The lift members comprise head end lift legs 176 and foot end lift legs (not shown). Timing links 240, like those in the lift assembly 170, are also present. The lift assembly 670 employs the guides 100, 102 and guided bodies 108 of the lift assembly 70. Only the guides 100 are shown.

In this lift assembly 670, the actuators that move the lift legs 176 to lift and lower the support frame 36 relative to the base 34 are the same as the second actuator 310 of the lift assembly 170 and comprise the transaxle transmission 320 to which the second motor 314 is operatively connected to form a transaxle motor arrangement. In this version, the transaxle transmission 320 is connected to a drive shaft 671 fixed to the timing links 240 to rotate the timing links 240 about the pivot axis P4. The second motor 314 and the transaxle transmission 320 are shown fixed to the head end lift legs 176 via a cross member 315 so that as the second actuator 310 operates to rotate the drive shaft 671, the drive shaft 671 rotates relative to the head end lift legs 176 about pivot axis P4. This movement causes the other end of the timing links 240 to pivot about the pivot axis P3 relative to the base frame 35. This, in turn, pivots the lift legs 176 about the fixed upper pivot axes P2 and causes the guided bodies 108 to move longitudinally and vertically in the guides 100, 102.

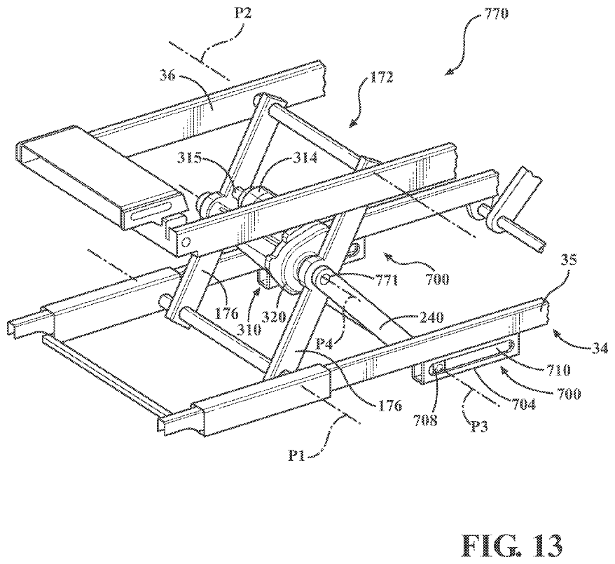

Referring to FIG. 13, an alternative lift assembly 770 is shown, which shares features of both of the previously described lift assemblies 70, 170. Like the lift assemblies 70, 170, the alternative lift assembly 770 has a pair of lift members that lift and lower the support frame 36 relative to the base 34. For simplicity, only the lift member 172 is shown. The lift members comprise head end lift legs 176 and foot end lift legs (not shown). Timing links 240, like those in the lift assembly 170, are also present.

In this version, the lift assembly 770 employs guides 700 and guided bodies 708. The guides 700 comprise a pair of head end guide tracks 704 and a pair of foot end guide tracks (not shown). In this lift assembly 770, the guide tracks 704 are fixed to the base frame 35 in a more central location to cooperate with the guided bodies 708. In this version, the guided bodies 708 are rotatably connected to one end of each of the timing links 240 (only one shown). Additionally, the first ends of the lift legs 176 are now pivotally connected to the base 34 at fixed pivot axes P1, unlike the prior versions in which the pivot axes P1 were movable. Likewise, the pivot axes P3 are now movable along the guides 700, as opposed to being fixed. In this version, the guides 700 may be placed in any suitable orientation to cause lifting and lowering of the support frame 36 relative to the base 34.

In this lift assembly 770, the rotary actuators 310 move the lift legs 176 to lift and lower the support frame 36 relative to the base 34. These rotary actuators 310 are the same as the second actuator 310 of the lift assembly 170. Like in the lift assembly 170, each of the actuators 310 comprises a transaxle transmission 320 to which a motor 314 is operatively connected to form a transaxle motor arrangement. In this version, the transaxle transmission 320 is connected to a drive shaft 771 fixed to the timing links 240 to rotate the timing links 240 about the pivot axis P4.

The motor 314 and the transaxle transmission 320 are shown fixed to the head end lift legs 176 via a cross member 315 so that as the actuator 310 operates to rotate the drive shaft 771, the drive shaft 771 rotates relative to the head end lift legs 176 about pivot axis P4. This movement causes the other end of the timing links 240 to pivot about the pivot axis P3, while the pivot axis P3 moves along the guides 700 via the guided bodies 708 relative to the base frame 35. This, in turn, pivots the lift legs 176 about the fixed upper pivot axes P2 and causes the lift legs 176 to extend or collapse relative to the base 34.

In additional versions (not shown), the components of the lift assemblies 170, 570, 670, 770 could be reversed, i.e., those coupled to the base 34, instead coupled to the support frame 36, and those coupled to the support frame 36, instead coupled to the base 34.

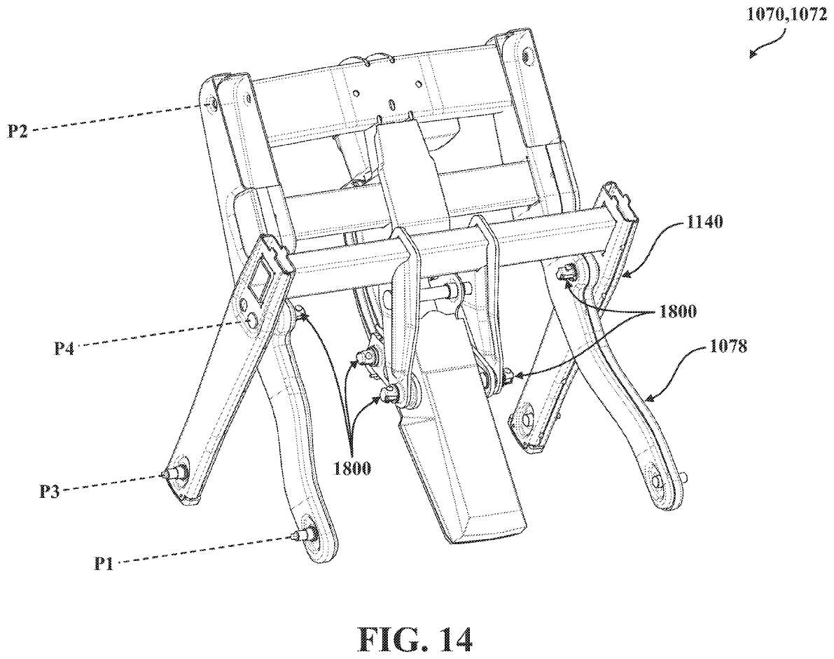

Referring now to FIG. 14, as noted above, portions of a lift member 1072 of another version of a lift assembly 1070 are shown, including lift legs 1078, timing links 1140, and other components similar to the other versions described herein. In the version shown, the lift member 1072 includes retention assemblies 1800 arranged at various axes to facilitate retention of various components along those axes. As will be appreciated from the subsequent description below, one or more retention assemblies 1800 could be employed at various locations, such as along the axis P4 between timing links 1140 and the lift legs 1078 to which they are pivotably coupled, as well as at other locations (see FIG. 14; multiple retention assemblies 1800 shown). Here too, it will be appreciated that the retention assemblies 1800 described herein could be utilized in connection with any of the versions of the present disclosure. Moreover, for the purposes of clarity, consistency, and brevity, the representative version of the lift member 1072 depicted in FIG. 14 will not be described in detail herein. However, in some versions, the illustrated lift member 1072 could be similar to as is described in U.S. Pat. No. 10,172,753, titled “Patient Support Lift Assembly,” and/or as is described in U.S. Pat. No. 10,736,803, titled “Lift Assembly for Patient Support Apparatus,” the disclosures of each of which are hereby incorporated by reference in their entirety.

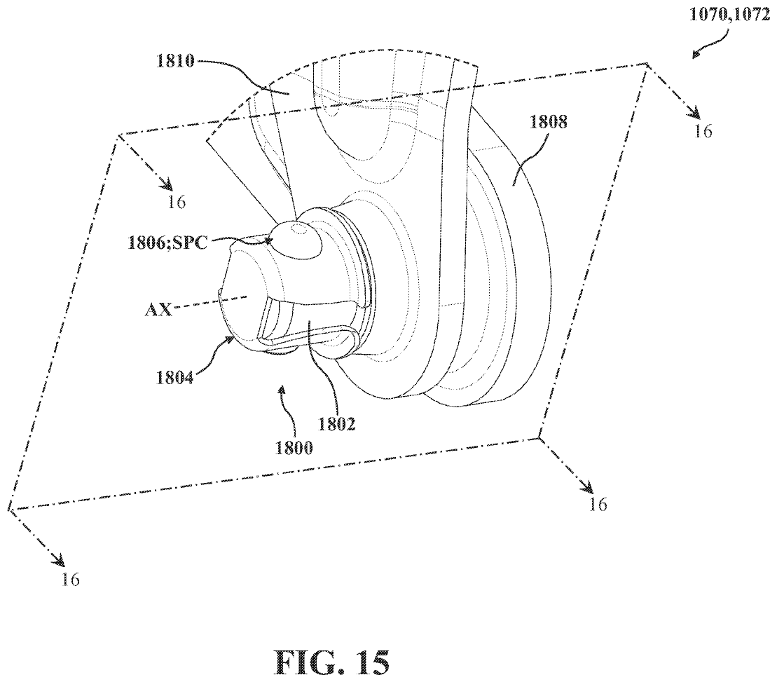

Referring now to FIGS. 15-17, the retention assembly 1800 generally includes a pin 1802, a retention cap 1804, and a cross-pin 1806, which cooperate to facilitate retention about an axis AX of one or more components of the lift member 1072. In the illustrated version, generically-depicted first and second link members 1808, 1810 are supported on the pin 1802 for relative pivoting movement about the axis AX of the retention assembly 1800 while, at the same time, being limited in their ability to translate relative to the pin 1802 along the axis AX by the retention cap 1804. Specifically, the retention cap 1804 is disposed on the pin 1802 to prevent axial movement of the first and second link members 1808, 1810. Because retention assemblies 1800 according to the present disclosure may be utilized in various locations on the patient support apparatus 30, it will be appreciated that the first and second link members 1808, 1810 could be defined by a variety of different components, including but not limited to the lift legs 1078 and the timing links 1140 illustrated in FIG. 14. Other configurations are contemplated. While the specific version shown is configured to facilitate rotation of each of the first and second link members 1808, 1810 about the pin 1802, in some versions the pin 1802 could take on some other form, such as being provided with a keyed interface that engages one of the first and second link members 1808, 1810. Other configurations are contemplated. Similarly, in other implementations, the pin may be integrated with or otherwise coupled to one side of the first link member without a first link aperture while still permitting relative pivoting movement between the first and second link members.

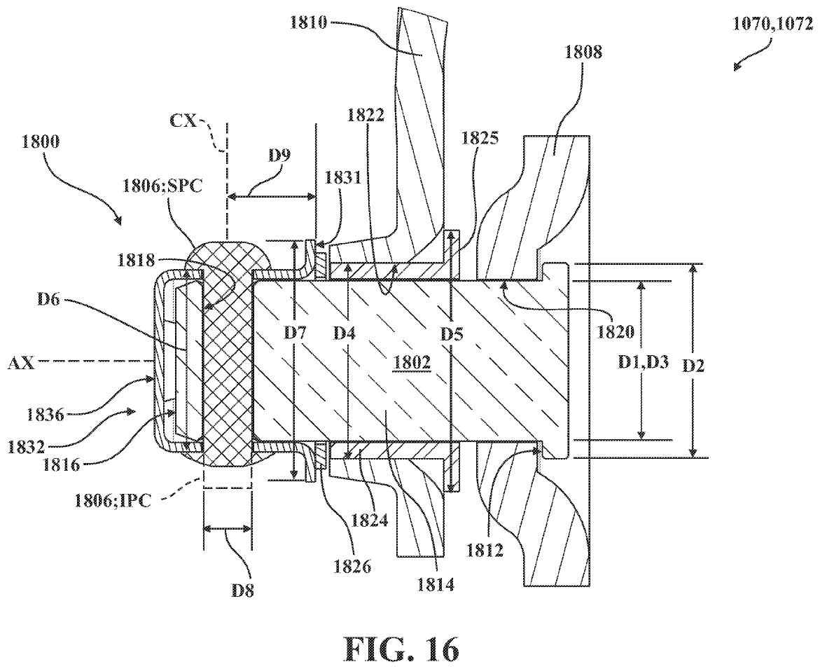

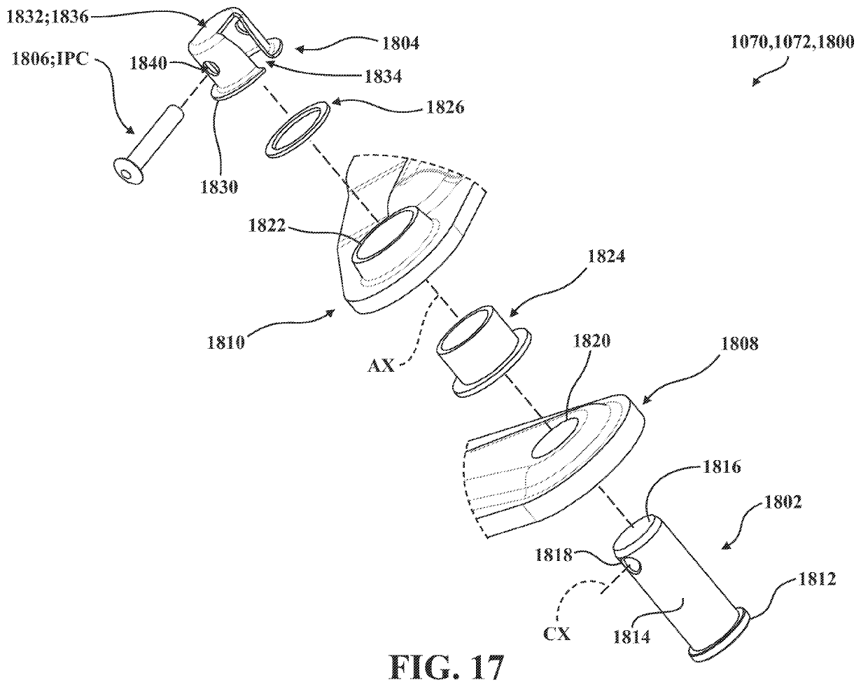

Best shown in FIGS. 16-17, in the illustrated version, the pin 1802 may have a pin flange 1812, from which a pin shank 1814 extends to a pin end 1816. The pin shank 1814 may have a pin diameter D1 and the pin flange 1812 may have a flange diameter D2. The first link member 1808 may define a first link aperture 1820, having a diameter D3, through which the pin shank 1814 extends. The flange diameter D2 of the pin flange 1812 may be greater than the diameter D3 of the first link aperture 1820. The pin flange 1812 may abut against a portion of the first link member 1808 (see FIG. 16) to limit axial movement of the pin 1802. Similarly, the second link member 1810 may define a second link aperture 1822 having a diameter D4. In the version illustrated in FIG. 16, the second link aperture 1822 may be larger in diameter than the first link aperture 1820 to receive a bearing element 1824 through which the pin shank 1814 extends to further facilitate pivoting movement of the second link member 1810. In this way, the pin 1802 may extend through each of the respective link apertures 1820, 1822 to facilitate the pivoting movement of the first and second link members 1808, 1810. However, other configurations are contemplated. The bearing element 1824 may comprise a bearing flange 1825 having a bearing flange diameter D5. The bearing flange diameter D5 may be greater than the diameter D4 of the second link aperture 1822. For example, in some implementations (not shown), the first link member may not have a first link aperture and instead the pin may be coupled to, or directly attached to, the first link member. It will further be appreciated that various types of bearing elements, such as bushings, plain bearings, roller bearings, or other support elements, may be arranged in one or more of the first and second link apertures 1820, 1822 in the respective link members 1808, 1810. The retention assembly 1800 may further comprise a pin washer 1826, which is arranged axially between the retention cap 1804 and the second link member 1810 (and also is arranged adjacent to a face of the bearing element 1824). Here, it will be appreciated that one or more washers may be provided in various locations.

The pin 1802 may further define a cross bore 1818 arranged proximate the pin end 1816. The cross bore 1818 of the pin 1802 extends through the pin shank 1814 along an axis CX, transverse to the axis AX; more specifically, the axis CX is perpendicular to the axis AX. Here, the cross bore 1818 is sized to receive the cross-pin 1806 in an initial pin configuration IPC (see FIG. 17). Once the other components of the retention assembly 1800 have been assembled along the pin 1802, the cross-pin 1806 can be placed into a secured pin configuration SPC (see FIGS. 15-16) to both retain and support the retention cap 1804 which, in turn, limits axial movement of the components supported along the pin 1802 and helps ensure smooth, consistent relative pivoting movement between the first and second link members 1808, 1810. Specifically, FIG. 16 shows the cross-pin 1806 in the secured pin configuration SPC using solid lines, and in the initial pin configuration IPC in phantom. The cross-pin 1806 is generally cylindrical having a diameter D8 and extending along a centerline, which is shown aligned with the axis CX when disposed in the cross-bore 1818. More specifically, in the exemplary implementation in which the cross-pin 1806 is illustrated as a rivet, one end of the cross-pin 1806 initially protrudes from a cap aperture 1840 (discussed below) and is deformed to move the cross-pin 1806 from the initial pin configuration IPC into the secured pin configuration SPC. To this end, it will be appreciated that various types of cross-pins 1806 may be utilized, including without limitation blind rivets, solid rivets, hollow rivets, multi-piece rivets, driven rivets, and the like that may be deformed or otherwise placed in the secured pin configuration SPC as pop-rivets, orbit rivets, and the like. It should be appreciated that the diameter D8 of the cross-pin 1806 is less than the pin diameter D1 of the pin 1802. For example, the pin diameter D1 may be at least 1.25× the diameter D8 of the cross-pin 1806. It should further be appreciated that the cross-pin 1806 may be implemented in other forms, such as a threaded fastener with tamper resistant or thread-locking features, an interference fit, a plain cross-pin retained with an adhesive or retaining compound, and the like.

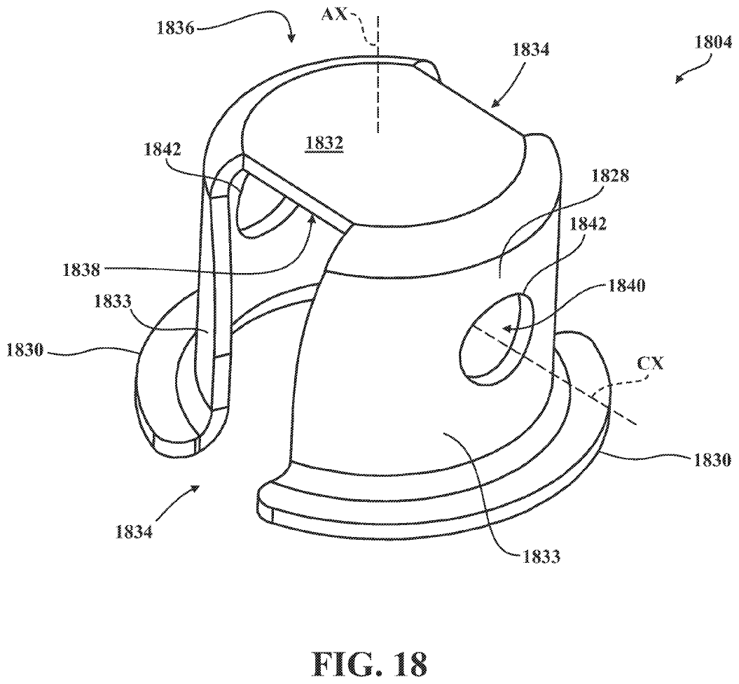

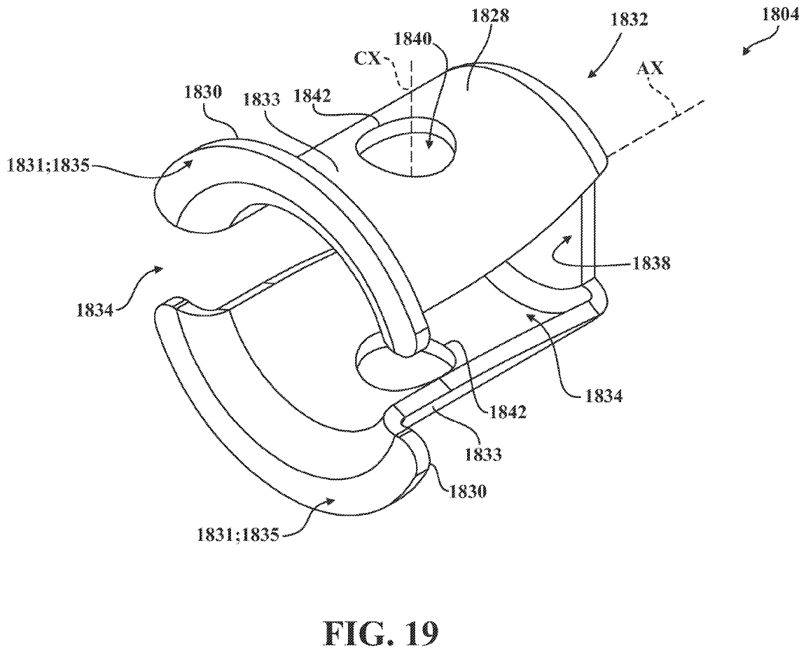

Referring now to FIGS. 18 and 19, the retention cap 1804 of the retention assembly 1800 has a retention body 1828 that extends generally between a retention flange 1830 and a retention end 1832. The retention end 1832 has a retention end diameter D6 and the retention flange has a retention flange diameter D7, with the retention flange diameter D7 being greater than the retention end diameter D6. The retention cap 1804 further includes a pair of resilient tangs 1833 radially spaced from each other about the axis AX. The resilient tangs 1833 and the retention flange 1830 are radially arranged to define a pair of gap reliefs 1834, which are formed extending laterally through the retention body 1828 and terminating adjacent respective portions of the retention end 1832. The retention flange 1830 defines a flange face 1831 arranged to at least partially limit movement of the second link member 1810 toward the retention end 1832. Here, the retention end 1832 has a generally flat profile and defines an outer cap face 1836 and an opposing inner cap face 1838. Each of the resilient tangs 1833 comprises a thrust face 1835 partially defining the flange face 1831 of the retention flange 1830. Each of the thrust faces 1835 is oriented away from the retention end 1832.

The retention body 1828 further defines a cap aperture 1840 formed extending along the axis CX, transverse to the axis AX, and arranged vertically between the retention flanges 1830 and the retention end 1832. The axis CX is spaced from the retention flange 1830 at a distance D9. Here, the cap aperture 1840 likewise receives the cross-pin 1806 in the initial pin configuration IPC (see FIG. 17). The cap aperture 1840 extends through each of the pair of resilient tangs 1833 to define two cap openings 1842 radially indexed about the axis AX between the pair of gap reliefs 1834. The cap aperture 1840 and the cap openings 1842 are indexed about the axis AX between the gap reliefs 1834 which, in turn, have profiles that widen towards the retention end 1832. The distance D9 may be chosen based on one or more factors and relationships. For example, the distance D9 between the retention flange 1830 and the axis CX may be related to the diameter D8 of the cross-pin 1806, the pin diameter D1 of the pin 1802, or the size of the tools (not shown) used to assemble the cross-pin 1806 in the cross bore 1818. In some implementations, the distance D9 is greater than the pin diameter D1. Alternatively, the distance D9 is greater than the diameter D8 of the cross-pin 1806. More specifically, the distance D9 may be at least 1.5× greater than the diameter D8 of the cross-pin 1806.

Here, the resilient tangs 1833 may form a generally cylindrical inner profile of the retention cap 1804. Each of the resilient tangs 1833 are biased toward each other to abut an outer surface of the pin shank 1814 when arranged on the pin end 1816 at least partially resist relative movement between the retention cap 1804 and the pin 1802. In this way, the resilient tangs 1833 may be slightly compressed against the pin 1802 when the retention cap 1804 is installed on the pin 1802, which facilitates assembly of the retention assembly 1800 by maintaining alignment between the cap aperture 1840 and the cross bore 1818 prior to inserting the cross-pin 1806 through the cap aperture 1840.

The retention flanges 1830 and thrust faces 1831 of the retention cap 1804 provide a bearing contact surface against whichever adjacent component is arranged along the pin 1802. In this way, the retention assembly 1800 affords the ability to provide rotational and axial support to the components supported on the retention cap 1804 while, at the same time, ensuring consistent pivoting movement between the first and second link members 1808, 1810. It will be appreciated that installation of the cross-pin 1806 occurring transverse to the axis AX affords significant advantages relating to the assembly, manufacture, and/or service of various components of the patient support apparatus 30. Specifically, by spacing the cross-pin 1806 from the second link member 1810, increased clearance is provided for a tool to be placed over one end of the cross-pin 1806 to deform the cross-pin 1806 from the initial pin configuration IPC and the secured pin configuration SPC. Moreover, the retention assembly 1800 is significantly more resistant to unauthorized disassembly or adjustment (i.e., “tamper-proof”) and also lower profile relative to the axis AX when compared to conventional fastening methodologies (e.g., cotter pins), while still allowing a technician to readily remove the cross-pin 1806 if required. Here too, the rigidity of the retention cap 1804 relative to the pin 1802 ensures a strong, stable bearing surface. In addition, it will be appreciated that the retention assembly 1800 can both be assembled and removed using proper tools with significantly reduced risk of damaging other components (e.g., marring surface finishes that could lead to corrosion, increased wear, and the like).

In view of the above, a method of assembling the patient support apparatus 30 is further disclosed. As is described in detail above, the patient support apparatus 30 may comprise a base 34 and a lift assembly 1070 supported by the base 34. The lift assembly 1070 may comprise several lift members, such as the first link member 1808 and a second link member 1810, each of which may define a respective link aperture 1820, 1822. The lift assembly 1070 may further comprise the retention assembly 1800, which comprises the pin 1802, the retention cap 1804, and the cross-pin 1806.

The method of assembling the patient support apparatus 30 includes a step of inserting the pin end 1816 of the pin 1802 into the link apertures 1820, 1822 of the first link member 1808 and the second link member 1810. With the first link member 1808 and the second link member 1810 supported on the pin shank 1814 and arranged on the axis AX, the pin washer 1826 may further be arranged on the pin shank 1814 adjacent to the second link member 1810. In some implementations of the lift assembly 1070, the second link member 1810 may be provided with the bearing element 1824. Here, the bearing element 1824 may be arranged in the link aperture 1822 of the second link member 1810 prior to the pin 1802 being inserted though the bearing element 1824 and the link aperture 1822. In some implementations, the bearing element 1824 may be provided with the bearing flange 1825. Here, the bearing element 1824 is arranged in the second link aperture 1822 such that the bearing flange 1825 is positioned between the first link member 1808 and the second link member 1810.

The retention cap 1804 is arranged on the pin end 1816 and rotated to align the cap aperture 1840 with the cross bore 1818 defined in the pin 1802. Due to the inward bias of the resilient tangs 1833, the inner surface of the retention cap 1804 grips the outer surface of the pin shank 1814, which resists relative movement between the pin 1802 and the retention cap 1804, thereby making assembly of the lift assembly 1070 easier and faster.

Following the step of arranging the retention cap 1804 on the pin end 1816, the cross-pin 1806 is inserted through the cap aperture 1840 and cross bore 1818 in the initial pin configuration IPC. Subsequently, the cross-pin 1806 is moved into the secured pin configuration SPC. Here, the cross-pin 1806 takes the form of a rivet, which is inserted in the cross bore 1818 such that a portion of the cross-pin 1806 protrudes from one of the cap openings 1842 of the cap aperture 1840. Moving the rivet from the initial pin configuration IPC to the secured pin configuration SPC is further defined as deforming one end of the rivet to expand the diameter D8 of the rivet. Deforming a head of the rivet may be performed using one or more of the tools described above, such as a riveting tool, an orbital riveter, a hammer, and the like.

Several instances have been discussed in the foregoing description. However, the aspects discussed herein are not intended to be exhaustive or limit the disclosure to any particular form. Various modifications to these aspects will be readily apparent to those skilled in the art, and the generic principles defined herein may be applied to other aspects without departing from the scope of the disclosure. The terminology that has been used is intended to be in the nature of words of description rather than of limitation. Many modifications and variations are possible in light of the above teachings and the disclosure may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient support apparatus comprising:
a base;
a support frame supported by the base;
a patient support deck disposed on the support frame and defining a patient support surface;
a lift assembly operatively arranged between the base and the support frame and configured to effect movement of the support frame relative to the base, the lift assembly including:
   a first link and a second link each defining a respective link aperture;
   a retention assembly disposed in each of the link apertures to pivotably couple the first link to the second link, the retention assembly comprising:
      a pin extending along a pivot axis to a pin end and disposed in each of the link apertures and defining a cross bore;
      a retention cap defining a cap aperture extending therethrough, wherein the retention cap is disposed on the pin with the cap aperture aligned with the cross bore; and
      a cross-pin disposed in the cross bore and protruding from the cap aperture configured to retain the retention cap to the pin and limit axial movement of the first and second links.
II. The patient support apparatus of clause I, wherein the cross bore is arranged perpendicular to the pivot axis and wherein the pin end is received in the retention cap.
III. The patient support apparatus of clause II, wherein the pin comprises a pin flange opposite the pin end, and wherein the first link and the second link are arranged along the pin between the pin flange and the pin end.
IV. The patient support apparatus of clause III, wherein the link aperture in the first link defines a first aperture diameter and the pin flange defines a pin flange diameter, and wherein the pin flange diameter is greater than the first aperture diameter.
V. The patient support apparatus of any of clauses I-IV, wherein the retention cap comprises a retention body extending between a retention end and a retention flange having a diameter larger than the retention end, wherein the retention flange defines a flange face arranged to at least partially limit movement of the second link toward the retention end.
VI. The patient support apparatus of clause V, wherein the retention assembly further comprises a washer interposed in contact between the retention flange and an engagement surface defined on the second link adjacent to the link aperture.
VII. The patient support apparatus of clause V, wherein the retention cap includes a pair of resilient tangs radially spaced from each other about an axis to define a pair of gap reliefs, wherein the pair of resilient tangs are biased towards each other and in abutment with the pin.
VIII. The patient support apparatus of clause VII, wherein the cap aperture extends through each of the pair of resilient tangs to define two cap openings radially indexed about the pivot axis between the pair of gap reliefs.
IX. The patient support apparatus of clause VII, wherein each of the pair of resilient tangs comprises a thrust face partially defining the flange face of the retention flange, wherein the thrust face is oriented away from the retention end.
X. The patient support apparatus of clause V, wherein an axis of the cap aperture is spaced from the flange face at a distance at least I.Vx greater than a diameter of the cross-pin.
XI. The patient support apparatus of clause V, wherein a diameter of the pin is as least I.XXVx greater than a diameter of the cross-pin.
XII. The patient support apparatus of any of clauses I-XI, wherein the lift assembly further comprises a bearing element disposed in the link aperture of the second link.
XIII. The patient support apparatus of clause XII, wherein the bearing element is further defined as a plain bearing comprising a bearing flange, and wherein the bearing flange is arranged between the first link and the second link.
XIV. The patient support apparatus of clause XIII, wherein the link aperture in the second link defines a second aperture diameter and the bearing flange defines a bearing flange diameter, and wherein the bearing flange diameter is greater than the second aperture diameter.
XV. The patient support apparatus of any of clauses I-XIV, wherein the cross-pin is further defined as a rivet.
XVI. A method of assembling a patient support apparatus including a base and a lift assembly having a first link and a second link each defining a link aperture and supported by the base, the lift assembly further including a retention assembly including a pin defining a cross bore, a retention cap defining a cap aperture, and a rivet, the method comprising:
inserting the pin into the link aperture of the first link and the second link;
arranging the retention cap on an end of the pin;
aligning the cap aperture with the cross bore;
inserting the rivet through the cap aperture and the cross bore in an initial configuration; and
deforming the rivet from the initial configuration to a secured configuration.
XVII. The method of clause XVI, wherein the pin extends along a pin axis from a pin flange to a pin end, and wherein the cross bore is arranged proximate to the pin end.
XVIII. The method of any of clauses XVI-XVII, wherein the retention assembly further includes a bearing element having a bearing flange, and further comprising a step of inserting the bearing element in the link aperture of the second link with the bearing flange arranged between the first link and the second link.
XIX. The method of any of clauses XVI-XVIII, wherein the retention cap includes a pair of resilient tangs radially spaced from each other about an axis and biased toward each other into abutment with the pin to at least partially resist relative movement between the retention cap and the pin.
XX. A retention assembly for a pivoting connection of a lift assembly for a patient support apparatus, the retention assembly comprising:
a pin extending along a pivot axis from a pin flange to a pin end and defining a cross bore proximate to the pin end;
a retention cap comprising a retention body extending between a retention flange and a retention end with a cap aperture defined in the retention body, wherein the retention cap is disposed on the pin end with the cap aperture aligned with the cross bore; and
a cross-pin disposed in the cross bore and protruding from the cap aperture configured to retain the retention cap to the pin and limit axial movement of the pivoting connection.
XXI. The retention assembly of clause XX, wherein the cross bore is arranged perpendicular to the pivot axis.
XXII. The retention assembly of any of clauses XX-XXI, wherein a pair of gap reliefs are defined in the retention body and wherein the cap aperture is further defined as a pair of cap apertures, and wherein each of the pair of cap apertures are arrange on the retention body and indexed about the pivot axis between the pair of gap reliefs.
XXIII. The retention assembly of any of clauses XX-XXII, further comprising a bearing supported on the pin between the pin flange and the retention flange.
XXIV. The retention assembly of any of clauses XX-XXIII, wherein the cross-pin is further defined as a rivet having an initial configuration and being at least partially deformable from the initial configuration to a secured configuration.
XXV. A patient support apparatus comprising:
a base;
a support frame supported by the base;
a patient support deck disposed on the support frame and defining a patient support surface;
a lift assembly operatively arranged between the base and the support frame and configured to effect movement of the support frame relative to the base, the lift assembly including:
   a first lift member,
   a pin operatively attached to the first lift member and extending along an axis to a pin end, the pin defining a cross bore proximate the pin end and extending therethrough transverse to the axis,
   a second lift member defining a link aperture pivotably supported about the pin,
   a retention cap disposed at the pin end of the pin and defining a cap aperture aligned with the cross bore of the pin, and
   a cross-pin disposed in the cross bore and protruding from the cap aperture configured to retain the retention cap to the pin and limit axial movement of the first and second lift members.
XXVI. The patient support apparatus of clause XXV, wherein the first lift member is further defined as a first link defining a first link aperture;
wherein the second lift member is further defined as a second link defining a second link aperture; and
wherein the pin is disposed in each of the first link aperture and the second link aperture to operatively attach the second link to the pin.

1. A patient support apparatus comprising:
a base;
a support frame supported by the base;
a patient support deck disposed on the support frame and defining a patient support surface;
a lift assembly operatively arranged between the base and the support frame and configured to effect movement of the support frame relative to the base, the lift assembly including:
a first link and a second link each defining a respective link aperture;
a retention assembly disposed in each of the link apertures to pivotably couple the first link to the second link, the retention assembly comprising:
a pin extending along a pivot axis to a pin end and disposed in each of the link apertures and defining a cross bore;
a retention cap defining a cap aperture extending therethrough, wherein the retention cap is disposed on the pin with the cap aperture aligned with the cross bore; and
a cross-pin disposed in the cross bore and protruding from the cap aperture configured to retain the retention cap to the pin and limit axial movement of the first and second links.

2. The patient support apparatus of claim 1, wherein the cross bore is arranged perpendicular to the pivot axis and wherein the pin end is received in the retention cap.

3. The patient support apparatus of claim 2, wherein the pin comprises a pin flange opposite the pin end, and wherein the first link and the second link are arranged along the pin between the pin flange and the pin end.

4. The patient support apparatus of claim 3, wherein the link aperture in the first link defines a first aperture diameter and the pin flange defines a pin flange diameter, and wherein the pin flange diameter is greater than the first aperture diameter.

5. The patient support apparatus of claim 1, wherein the retention cap comprises a retention body extending between a retention end and a retention flange having a diameter larger than the retention end, wherein the retention flange defines a flange face arranged to at least partially limit movement of the second link toward the retention end.

6. The patient support apparatus of claim 5, wherein the retention assembly further comprises a washer interposed in contact between the retention flange and an engagement surface defined on the second link adjacent to the link aperture.

7. The patient support apparatus of claim 5, wherein the retention cap includes a pair of resilient tangs radially spaced from each other about an axis to define a pair of gap reliefs, wherein the pair of resilient tangs are biased towards each other and in abutment with the pin.

8. The patient support apparatus of claim 7, wherein the cap aperture extends through each of the pair of resilient tangs to define two cap openings radially indexed about the pivot axis between the pair of gap reliefs.

9. The patient support apparatus of claim 7, wherein each of the pair of resilient tangs comprises a thrust face partially defining the flange face of the retention flange, wherein the thrust face is oriented away from the retention end.

10. The patient support apparatus of claim 5, wherein an axis of the cap aperture is spaced from the flange face at a distance at least 1.5× greater than a diameter of the cross-pin.

11. The patient support apparatus of claim 5, wherein a diameter of the pin is as least 1.25× greater than a diameter of the cross-pin.

12. The patient support apparatus of claim 1, wherein the lift assembly further comprises a bearing element disposed in the link aperture of the second link.

13. The patient support apparatus of claim 12, wherein the bearing element is further defined as a plain bearing comprising a bearing flange, and wherein the bearing flange is arranged between the first link and the second link.

14. The patient support apparatus of claim 13, wherein the link aperture in the second link defines a second aperture diameter and the bearing flange defines a bearing flange diameter, and wherein the bearing flange diameter is greater than the second aperture diameter.

15. The patient support apparatus of claim 1, wherein the cross-pin is further defined as a rivet.

16. A method of assembling a patient support apparatus including a base and a lift assembly having a first link and a second link each defining a link aperture and supported by the base, the lift assembly further including a retention assembly including a pin defining a cross bore, a retention cap defining a cap aperture, and a rivet, the method comprising:
inserting the pin into the link aperture of the first link and the second link;
arranging the retention cap on an end of the pin;
aligning the cap aperture with the cross bore;
inserting the rivet through the cap aperture and the cross bore in an initial configuration; and
deforming the rivet from the initial configuration to a secured configuration.

17. The method of claim 16, wherein the pin extends along a pin axis from a pin flange to a pin end, and wherein the cross bore is arranged proximate to the pin end.

18. The method of claim 16, wherein the retention assembly further includes a bearing element having a bearing flange, and further comprising a step of inserting the bearing element in the link aperture of the second link with the bearing flange arranged between the first link and the second link.

19. The method of claim 16, wherein the retention cap includes a pair of resilient tangs radially spaced from each other about an axis and biased toward each other into abutment with the pin to at least partially resist relative movement between the retention cap and the pin.

20. A retention assembly for a pivoting connection of a lift assembly for a patient support apparatus, the retention assembly comprising:
a pin extending along a pivot axis from a pin flange to a pin end and defining a cross bore proximate to the pin end;
a retention cap comprising a retention body extending between a retention flange and a retention end with a cap aperture defined in the retention body, wherein the retention cap is disposed on the pin end with the cap aperture aligned with the cross bore; and
a cross-pin disposed in the cross bore and protruding from the cap aperture configured to retain the retention cap to the pin and limit axial movement of the pivoting connection.

21. (canceled)

22. (canceled)

23. (canceled)

24. (canceled)

25. (canceled)

26. (canceled)
